(19) United States
(12) Patent Application Publication
(10) Pub. No.: US 2013/0182827 A1
(43) Pub. Date: Jul. 18, 2013

(54) X-RAY WAVEGUIDE AND X-RAY WAVEGUIDE SYSTEM

(71) Applicant: CANON KABUSHIKI KAISHA, Tokyo (JP)

(72) Inventors: Kohei Okamoto, Yokohama-shi (JP); Atsushi Komoto, Moriya-shi (JP); Hirokatsu Miyata, Hadano-shi (JP); Takashi Noma, Hadano-shi (JP)

(73) Assignee: CANON KABUSHIKI KAISHA, Tokyo (JP)

(21) Appl. No.: 13/690,447

(22) Filed: Nov. 30, 2012

(30) Foreign Application Priority Data
Dec. 2, 2011 (JP) 2011-265069

(51) Int. Cl. G21K 1/06

(52) U.S. Cl. CPC G21K 1/062; G21K 2201/061
USPC 378/145

(57) ABSTRACT

An X-ray waveguide includes a core having a curved portion and a cladding. The core has a periodic structure made of different substances periodically arrayed perpendicular to a guiding direction. A critical angle for total reflection of an X-ray at a core-cladding interface is larger than a Bragg angle of the periodic structure. A critical angle for the total reflection of the X-ray at a substance interface in the periodic structure is smaller than the Bragg angle. When s is a core width in a direction perpendicular to the guiding direction and parallel to a curvature radius of the curved portion, n_{low} is a refractive-index real part of the substance having a minimum real part of refractive index, n_{high} is a refractive-index real part of the substance having a maximum real part of refractive index, and R is the curvature radius, [s/ln(n_{high}/n_{low})]<R is satisfied.

### BACKGROUND OF THE INVENTION

1. Field of the Invention

The present invention relates to an X-ray waveguide and an X-ray waveguide system including an X-ray source and an X-ray waveguide. The X-ray waveguide according to an embodiment of the present invention can be used, for example, in X-ray optical systems for, e.g., X-ray analysis technology, X-ray imaging technology, and X-ray exposure technology, and further used as an X-ray optical component employed in the X-ray optical systems.

2. Description of the Related Art

An electromagnetic wave having a short wavelength of several tens nm or less, e.g., an X-ray, exhibits a very small difference in refractive index between different substances. As a result, a critical angle for the total reflection at an interface between the different substances is very small for the electromagnetic wave having, e.g., such a short wavelength. It is more difficult to control the electromagnetic wave having the short wavelength than to control an electromagnetic wave in a visible band, for example. Hitherto, a large-sized spatial optical system has mainly been used to control the electromagnetic wave having the short wavelength, e.g., the X-ray. One of main components constituting the large-sized spatial optical system is a multilayer mirror in which materials having different refractive indices are alternately laminated. The multilayer mirror has various functions, such as beam shaping, conversion of a spot size, and wavelength selection. In that type of X-ray spatial optical system, total reflection at a substance interface or Bragg reflection based on periodicity of a periodic structure is employed to change the propagating direction of the X-ray. On the other hand, continuously bending the propagating direction of the X-ray is not generally performed.

Other than the above-mentioned spatial optical system having mainly been used so far, Japanese Patent No. 4133923 discloses an X-ray propagation element, called a polycapillary, in which a plurality of capillaries each in a form confining an X-ray inside a tube-shaped waveguide with total reflection are bundled together. According to the X-ray propagation element disclosed in Japanese Patent No. 4133923, because the X-ray is propagated while it is confined inside each capillary, the propagating direction of the X-ray can be changed by bending the polycapillary. Moreover, studies have also recently been made on a small-size X-ray waveguide, which is formed on a substrate, aiming to reduce the size and to enhance the performance of an optical system. One example is an X-ray waveguide in which the X-ray is confined in a core region sandwiched between claddings or surrounded by a cladding for propagation therethrough just by utilizing total reflection at an interface between the cladding and the core. In that type of X-ray waveguide described in “Applied Physics A”, Volume 91, Number 1, p. 7(2008) (hereinafter referred to as the “paper”), an X-ray waveguide is formed in a curved shape on a substrate to be able to continuously curve a guiding direction for the X-ray in a waveguide mode that is formed inside a core of the X-ray waveguide.

However, the following problem arises in the X-ray waveguide described in the above-mentioned paper, which employs a method of confining the X-ray inside the core with the total reflection at the interface between the core and the cladding, and bending the direction of the X-ray in a lower-order waveguide mode formed inside the waveguide. In order to construct the X-ray waveguide such that the lower-order, particularly 0th-order, waveguide mode becomes dominant in propagation of the X-ray, a cross-sectional diameter of the waveguide core has to be made very small, i.e., several tens nanometers. Accordingly, the X-ray can be propagated just in a very small amount.

The following problem arises in the X-ray propagation element described in Japanese Patent No. 4133923, which relates to the technique of confining the X-ray inside the capillary and bending the propagating direction of the X-ray by bending the capillary. Because the diameter of the capillary is too large, there occurs a situation where the concept of “waveguide mode” does not hold with respect to the X-ray propagating through the capillary. In other words, the propagating direction of the X-ray can be bent, but a phase of the X-ray propagating through the capillary is not spatially uniform in a plane perpendicular to the direction of length of the capillary.

### SUMMARY OF THE INVENTION

In view of the problems described above, an embodiment of the present invention provides an X-ray waveguide including a core configured to guide an X-ray therethrough and a cladding configured to confine the X-ray inside the core. The core has a periodic structure in which plural substances each having a different real part of refractive index are periodically arrayed in a direction perpendicular to an interface between the core and the cladding. A critical angle for the total reflection of the X-ray at the interface between the core and the cladding is larger than a Bragg angle attributable to the periodic structure of the core for the X-ray. A critical angle for the total reflection at an interface between the plural substances constituting the periodic structure of the core is smaller than the Bragg angle. The core includes a curved portion, and a following formula is satisfied:

$$\frac{s}{ln ( \frac{{n}_{high}}{{n}_{low}} )} < R$$

where s is a width of the core in a direction perpendicular to an X-ray guiding direction and parallel to a direction in which a curvature radius is defined of the curved portion, n_{low} is a refractive-index real part of the substance having a minimum real part of refractive index among the substances of the core, n_{high} is a refractive-index real part of the substance having a maximum real part of refractive index among the substances of the core, and R is the curvature radius of the curved portion.

Further features of the present invention will become apparent from the following description of exemplary embodiments with reference to the attached drawings.

### BRIEF DESCRIPTION OF THE DRAWINGS

FIG. 1 is a schematic sectional view of an X-ray waveguide in which a core has a periodic structure, the waveguide not including a curved portion.

FIG. 2 is an illustration to explain a wavevector and an effective propagation angle.

FIG. 3 is a graph representing an example of the relationship between a propagation loss and an effective propagation angle of each waveguide mode in a waveguide region of the X-ray waveguide according to an embodiment of the present invention.

FIG. 4 is a graph representing one example of a distribution of an electric field inside the core in a periodic resonant waveguide mode that is formed within the waveguide region of the X-ray waveguide according to the embodiment of the present invention.

FIG. 5 illustrates one example of a distribution of a refractive-index real part in a direction perpendicular to an interface between the core and a cladding in the X-ray waveguide according to the embodiment of the present invention.

FIG. 6 is a schematic sectional view illustrating one example of an X-ray waveguide, which includes a curved portion, according to the embodiment of the present invention.

FIG. 7 is a schematic sectional view illustrating one example of behavior of an X-ray guided through the X-ray waveguide according to the embodiment of the present invention.

FIG. 8 is a schematic sectional view illustrating an emergent end and thereabout of the X-ray waveguide according to the embodiment of the present invention.

FIG. 9 is a schematic sectional view of an X-ray waveguide of EXAMPLE 1.

FIG. 10 is a schematic sectional view of an X-ray waveguide of EXAMPLE 2.

FIG. 11 is a schematic perspective view of an X-ray waveguide used in EXAMPLE 5.

FIG. 12 is a schematic view illustrating an X-ray guiding direction in the X-ray waveguide of EXAMPLE 5.

### DESCRIPTION OF THE EMBODIMENTS

An embodiment of the present invention will be described in detail below.

An X-ray waveguide according to the embodiment includes a core configured to guide an X-ray therethrough and a cladding configured to confine the X-ray inside the core. The core has a periodic structure in which plural substances each having a different real part of refractive index are periodically arrayed in a direction perpendicular to an X-ray guiding direction. A critical angle for the total reflection of the X-ray at an interface between the core and the cladding is larger than a Bragg angle attributable to periodicity of the periodic structure of the core for the X-ray. A critical angle for the total reflection at an interface between the plural substances constituting the periodic structure is smaller than the Bragg angle attributable to the periodicity of the periodic structure of the core for the X-ray. The core includes a curved portion, and the following formula (1) is satisfied:

$$\frac{s}{ln ( \frac{{n}_{high}}{{n}_{low}} )} < R \qquad ( 1 )$$

where s is a width of the core in a direction perpendicular to an X-ray guiding direction and parallel to a direction in which a curvature radius is defined (direction of a curvature radius) of the curved portion, n_{low} is a refractive-index real part of the substance having a minimum real part of refractive index among the substances of the core, n_{high} is a refractive-index real part of the substance having a maximum real part of refractive index among the substances of the core, and R is the curvature radius of the curved portion.

In the present disclosure, the term “X-ray” implies an electromagnetic wave in a wavelength band where a real part of the refractive index of a substance has a value of 1 or less. More specifically, in the present disclosure, the term “X-ray” implies an electromagnetic wave in a wavelength range of 1 pm or longer to 100 nm or shorter, including Extreme Ultra Violet (EUV) light. A frequency of the electromagnetic wave having such a short wavelength is very high and an outermost electron of a substance is not responsible to that electromagnetic wave. It is hence known that a real part of the refractive index of a substance has a value of smaller than 1 for the X-ray unlike for electromagnetic waves (visible light and infrared light) in a frequency band where wavelengths are not shorter than that of ultraviolet light. The refractive index of a substance for the X-ray is expressed by a complex number. In this specification, a real part of the complex number as the refractive index is called a “refractive-index real part” or a “real part of the refractive index”, and an imaginary part of the complex number is called a “refractive-index imaginary part” or an “imaginary part of the refractive index”.

Given that the refractive-index real part is n′, a deviation of n′ from 1 is δ, and the refractive-index imaginary part relating to absorption is β′, a refractive index n of a substance for the above-mentioned X-ray is generally expressed by the following formula (2):

n=1−δ−iβ′=n′−iβ′ (2)

Because δ is proportional to an electron density ρₑ of a substance, the refractive-index real part has a smaller value as the substance has a larger electron density. The refractive-index real part n′ is expressed by:

n′=(1−δ)

Moreover, the electron density ρₑ is proportional to an atomic density ρₐ and an atomic number Z. Thus, in the present disclosure, “two or more substances each having a different real part of refractive index” can also be expressed as “two or more substances having different electron densities” in many cases.

The refractive-index real part is maximized for the X-ray when the X-ray propagates in vacuum. In typical environments on the earth, the refractive-index real part is maximized in air in comparison with those of almost all substances other than gases. The term “substance” used in this specification involves air and vacuum. In the X-ray waveguide according to the embodiment, the X-ray is confined inside the core with total reflection of the X-ray at the interface between the core and the cladding to form a waveguide mode, thereby causing the X-ray to propagate through the X-ray waveguide. A direction in which the X-ray is guided to propagate in the waveguide mode formed at that time is called a “(X-ray) guiding direction” in this specification. The guiding direction is the same as an X-ray propagating direction that is obtained on the basis of the theory of the waveguide. In many of general forms of X-ray waveguides according to embodiments of the present invention, the guiding direction is given as a direction that is parallel to the interface between the core and the cladding and that is perpendicular to the direction of the curvature radius of the curved portion. Now, the direction of the curvature radius is along the direction in which the curvature radius is defined.

Furthermore, the core of the X-ray waveguide according to the embodiment has the periodic structure in which the refractive-index real part exhibits a periodic distribution in a direction perpendicular to or substantially perpendicular to the interface between the core and the cladding. The waveguide mode used in the embodiment is a waveguide mode resonant with periodicity of the periodic structure of the core. That waveguide mode is called a “periodic resonant waveguide mode” in this specification.

The periodic resonant waveguide mode will be described below, for example, with reference to the case where the guiding direction of the X-ray waveguide is linear. It is to be noted that, since the X-ray waveguide according to the embodiment of the present invention includes the curved portion, the following description is just a reference for easier understanding of the present invention.

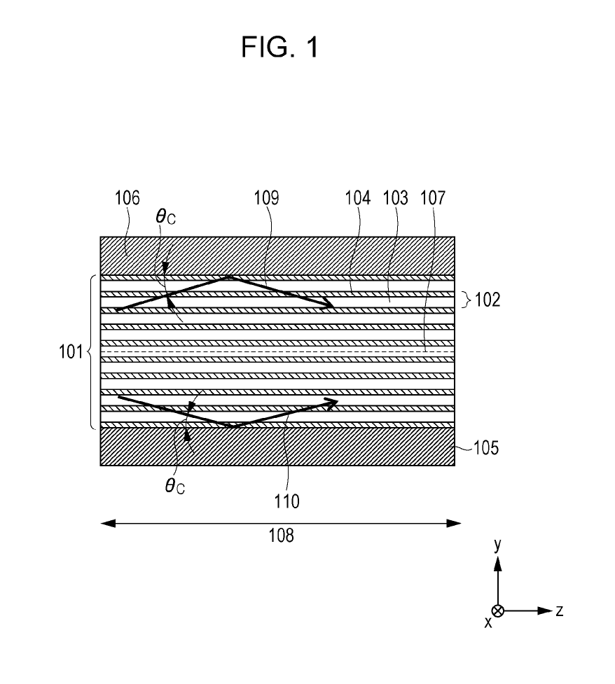

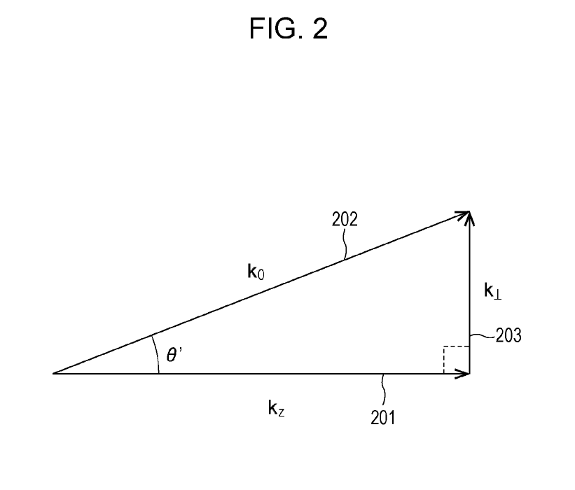

FIG. 1 is a schematic sectional view of an X-ray waveguide in which a core has a periodic structure, the waveguide not including a curved portion. The X-ray waveguide of FIG. 1 represents the case where the guiding direction of the X-ray waveguide is linear. A core 101 is sandwiched between claddings 105 and 106, and the periodic structure constituting the core is made up of a plurality of unit structures 102 each corresponding to one period. The unit structures 102 is constituted by a substance 103 having a relatively large real part of refractive index and a substance 104 having a relatively small real part of refractive index. Thus, the core is in the form of a multilayer film having a one-dimensional periodic structure in a direction (y-direction in FIG. 1) that is perpendicular to an interface between the core 101 and the cladding 105, or an interface between the core 101 and the cladding 106. Arrows 109 and 110 represent, for example, behaviors of X-rays propagating through the core and being totally reflected by the interface between the core and the cladding. The illustrated example represents the case where the X-ray is totally reflected upon impinging against the interface at a critical angle for the total reflection, and the critical angle for the total reflection is denoted by θ_{c}. In this specification, all angles are each defined in a plane, which is parallel to the guiding direction and is perpendicular to the interface between the core and the cladding, with respect to an X-ray of one target wavelength on condition that an angle in the guiding direction is 0°. The guiding direction is given as a locus that is drawn by a center of the core in the direction perpendicular to the interface between the core and the cladding. In the illustrated example, a dotted line 107 represents such a locus. In FIG. 1, the direction of the locus is matched with the z-direction. Furthermore, in this specification, the length of the waveguide represents the length of the locus. The critical angle for the total reflection of the X-ray at an interface between the substance 103 and the substance 104 in the unit structure 102 is defined as θ_{c-in} in this specification. Moreover, the Bragg angle attributable to the periodicity of the periodic structure of the core 101 is denoted by θ_{B} in this specification. The Bragg angle θ_{B} is an incidence angle of the X-ray with respect to the periodic structure, at which the X-ray is strongly reflected as a result of multiple interference in the periodic structure when the X-ray is applied to the periodic structure. The Bragg angle θ_{B} is determined depending on the wavelength of the X-ray and the periodicity of the periodic structure. Here, an effective propagation angle of a fundamental wave of the periodic resonant waveguide mode in the X-ray waveguide according to the embodiment of the present invention is an angle substantially equal to the Bragg angle. Based on approximation that the waveguide mode is formed by interference when one plane wave propagates while repeating total reflection at the interface between the core and the cladding, the fundamental wave represents that one plane wave. As illustrated in FIG. 2, when, of wavevectors of the waveguide mode, a wavevector 201 parallel to the guiding direction is denoted by k_{z}=(0, 0, k_{z}), the fundamental wave is defined as a plane wave having a wavevector 202, denoted by k₀, in vacuum. In this respect, an angle formed between the wavevector k₀ and the wavevector k_{z} is called an effective propagation angle θ′(°), and the wavevectors and the effective propagation angle θ′ are correlated by the following formula (4). A wavevector k_{⊥} 203 represents a wavevector component in the direction perpendicular to the interface between the core and the cladding, i.e., in the direction perpendicular to the guiding direction.

$${θ}^{′} = arccos ( \frac{\vert {k}_{z} \vert}{\vert {k}_{0} \vert} ) \qquad ( 4 )$$

An actual Bragg angle has a width that is called a Bragg angle range. However, the Bragg angle in the present disclosure is regarded as representing the effective propagation angle of the fundamental wave in the periodic resonant waveguide mode, and it is given as a minimum angle in the actual Bragg angle range. The periodic resonant waveguide mode is a waveguide mode that is formed through a process in which an X-ray causes multiple interference by repeating partial reflection and refraction at each interface in the periodic structure, and it eventually resonates with the periodicity of the periodic structure. In order to realize the multiple interference, the X-ray waveguide according to the embodiment of the present invention is featured in that the critical angle for the total reflection θ_{c-in} of the X-ray at a substance interface between the substance 103 and the substance 104 in the unit structure 102 is smaller than the Bragg angle θ_{B} attributable to the periodicity of the periodic structure of the core 101. Such a condition is expressed by the following formula (5). Note that the Bragg angle θ_{B} is determined depending on the relationship between the periodicity of the periodic structure of the core and the wavelength of the X-ray.

θ_{c-in}<θ_{B} (5)

In order to confine, inside the core, the X-ray that is obtained with the multiple interference and that resonates with the periodicity of the periodic structure, the X-ray waveguide according to the embodiment of the present invention is further featured in that the critical angle for the total reflection θ_{c} at the interface between the core and the cladding is larger than the Bragg angle θ_{B} attributable to the periodicity of the periodic structure of the core. Such a condition is expressed by the following formula (6).

θ_{c}>θ_{B} (6)

By satisfying the above-described features, the periodic resonant waveguide mode, i.e., the waveguide mode resonant with the periodicity of the core, can be formed in the X-ray waveguide according to the embodiment.

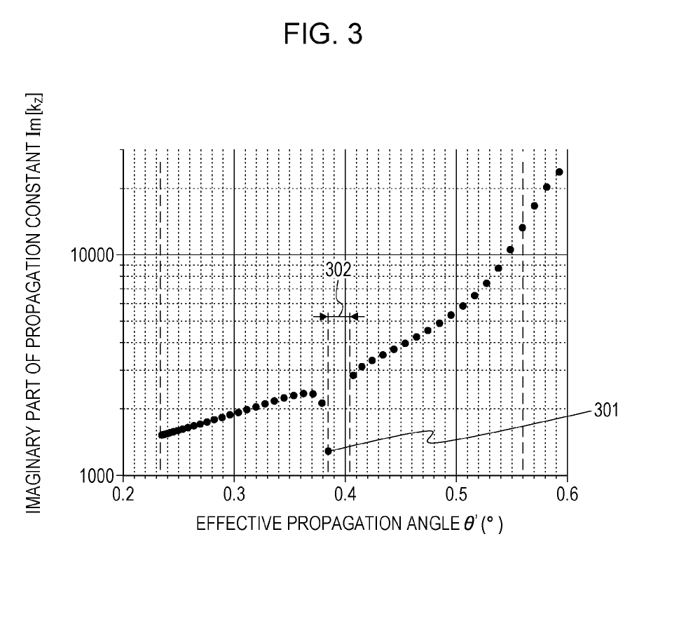

FIG. 3 is a graph representing the relationship between a propagation loss and the effective propagation angle θ′(°) of each waveguide mode formed in the example of the linear X-ray waveguide illustrated in FIG. 1. The graph is based on calculation results. In the graph, the vertical axis indicates an imaginary part Im [k_{z}] of the propagation constant of each waveguide mode as an index of the propagation loss. The X-ray waveguide illustrated in FIG. 1 is constructed with satisfaction of the formulae (5) and (6), and the core has a multilayer film structure. While waveguide modes have discrete effective propagation angles in accordance with the orders thereof, there is an effective propagation angle range, as illustrated in FIG. 3, where any waveguide mode cannot exist. Such an effective propagation angle range is a Bragg angle range 302, and a minimum angle of the Bragg angle range is called the “Bragg angle” in this specification. That Bragg angle can be approximately regarded as the effective propagation angle of the periodic resonant waveguide mode. Thus, as seen from FIG. 3, the waveguide mode denoted by 301 represents the periodic resonant waveguide mode, and the propagation loss of the periodic resonant waveguide mode is significantly smaller than those of other waveguide modes having effective propagation angles close to that of the periodic resonant waveguide mode. This implies that the waveguide mode having a very small propagation loss can be formed by the X-ray waveguide according to the embodiment. Because the propagation loss of the periodic resonant waveguide mode is significantly small, the X-ray of the periodic resonant waveguide mode becomes dominant in the X-ray waveguide. As a result, the X-ray can be guided in the periodic resonant waveguide mode that is a substantially single waveguide mode. Furthermore, with the structure of the X-ray waveguide to form the periodic resonant waveguide mode, a cross-section of the core can be greatly increased in a plane perpendicular to the guiding direction, and an amount of the X-ray to be guided can be increased.

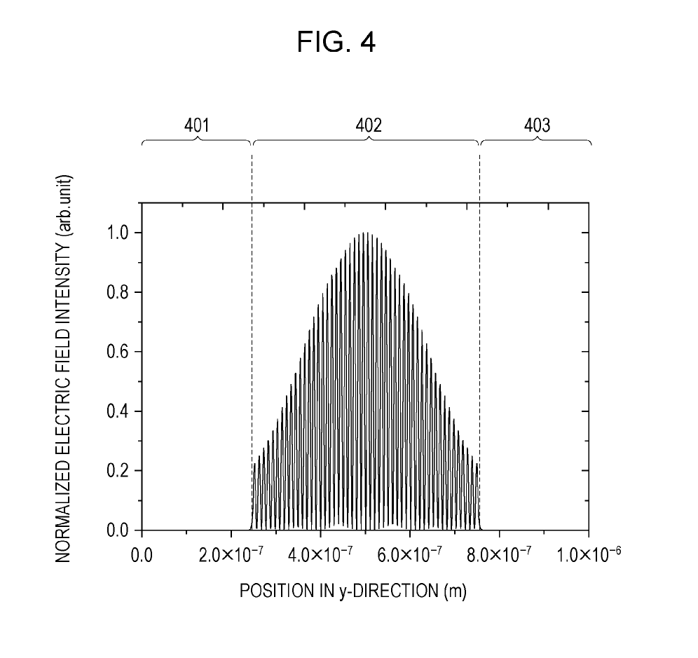

As a practical example, FIG. 4 represents a spatial distribution of electric field intensity in the periodic resonant waveguide mode when the core is in the form of a multilayer film with s periodic number of 50. In the waveguide having such a structure, as illustrated in FIG. 4, the entire distribution of electric field intensity is localized toward a center of the core under an influence of periodicity of the multilayer film, and an amount of the X-ray seeped to the claddings, which exists as the evanescent field, is reduced, whereby the propagation loss can be reduced. In FIG. 4, the horizontal axis indicates a direction perpendicular to a surface of the multilayer film, i.e., the y-direction in FIG. 1. Numerals 401 and 403 correspond to the claddings, and 402 corresponds to the core. Moreover, as seen from the distribution of electric field intensity in the periodic resonant waveguide mode, the number of antinodes of the electric field intensity distribution is matched with the periodic number of the periodic structure, and the electric field is concentrated in each portion of the multilayer film, which is made of the substance exhibiting smaller absorption, whereby the propagation loss is further reduced. With the above-described features that the periodic resonant waveguide mode can be formed as the substantially single waveguide mode, and that the electric field is concentrated into a material exhibiting a smaller propagation loss and the distribution of electric field in the direction perpendicular to the interface between the core and the cladding has periodicity matched with the periodicity of the multilayer film, the periodic resonant waveguide mode has a uniform phase in the direction perpendicular to the interface between the core and the cladding. Thus, the single waveguide mode having a spatially uniform phase can be formed with the above-described basic structure of the linear X-ray waveguide. Here, the expression “uniform phase” implies not only the case where the phase difference in electromagnetic field is always 0, but also the case where the phase difference spatially periodically varies.

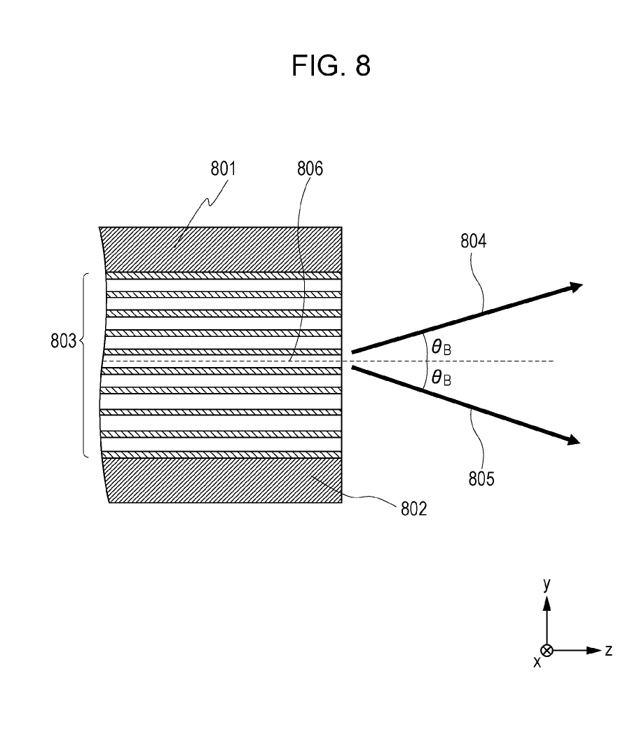

After the X-ray guided in the formed periodic resonant waveguide mode has exited an end surface of the waveguide, it forms propagating X-rays, which propagate in two directions with high intensity at very small divergence angles, in a far-field region as a result of Fraunhofer diffraction. Those X-rays are called “diffracted X-rays” in this specification. In a direction in which the periodicity is low, e.g., in a zx-plane direction in FIG. 1, the diffracted X-ray has a large divergence angle because it is not affected by the periodicity and is not controlled by the periodic structure. However, if there is periodicity in the zx-plane direction in FIG. 1, the divergence angle of the diffracted X-ray in the zx-plane direction can be reduced because the diffracted X-ray is affected by the periodicity. For explanation of the diffracted X-rays, FIG. 8 illustrates an emergent end and thereabout of the X-ray waveguide that includes a core 803 sandwiched by claddings 801 and 802. The guiding direction is parallel to the z-direction as denoted by a dotted line 806. Because the periodic structure of the core has periodicity in the y-direction, the X-ray emerging from the end of the waveguide forms diffracted X-rays 804 and 805 that are diffracted in two symmetric directions with respect to the z-axis in the far-field region. In this connection, the divergence angles of the two diffracted X-rays in the yz-plane become very small as if the X-rays are diffracted through a multi-slit. Furthermore, diffraction angles of the diffracted X-rays 804 and 805 with respect to the z-direction are each substantially equal to the Bragg angle as denoted in FIG. 8.

While the foregoing is the description about the waveguide not including the curved portion, the above-description is similarly applied to the X-ray waveguide according to the embodiment of the present invention insofar as there is no contradiction therebetween.

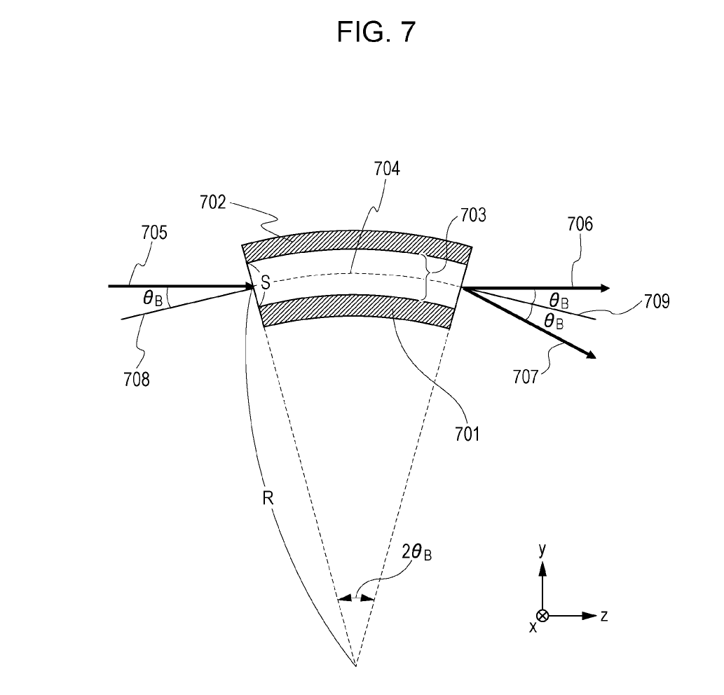

The X-ray waveguide according to the embodiment is featured in including a portion having a curved shape (i.e., a curved portion) where the direction of a fundamental vector representing the periodicity of the periodic structure is continuously changed. Furthermore, the X-ray guiding direction in the curved portion satisfies the above-mentioned formula (1), given that s is the width of the core in the direction perpendicular to the X-ray guiding direction in the curved portion and parallel to the direction of the curvature radius of the curved portion, n_{low} is the refractive-index real part of the substance having the minimum real part of refractive index among the substances of the core, n_{high} is the refractive-index real part of the substance having the maximum real part of refractive index among the substances of the core, and R is the curvature radius of the curved portion at a center of the waveguide in the curved portion. The “center of the waveguide” implies the center of the core in the direction perpendicular to the interface between the core and the cladding. When claddings 701 and 702 are present as illustrated in FIG. 7, the center of the waveguide can be said as being a set of midpoints each defined between one point on an interface between the cladding 701 and the core 703 and one point on an interface between the cladding 702 and the core 703, the latter point being closest to the former point. Alternatively, the center of the waveguide can be said as being present on an average line of two core-cladding interface lines appearing in the sectional view perpendicular to the guiding direction, i.e., on a center line between two core-cladding interface lines appearing in the sectional view perpendicular to the guiding direction. In accordance with that concept, when the cladding surrounds an entire periphery of the core, the center of gravity of a figure surrounded by a core-cladding interface line appearing in the sectional view perpendicular to the guiding direction can be said as the center of the waveguide.

By constructing the X-ray waveguide according to the embodiment as described above, the guiding direction for the X-ray in the periodic resonant waveguide mode can be continuously changed at the curvature radius R in the curved portion of the waveguide. In other words, it is possible to change the guiding direction for the X-ray that is confined inside the core having the wide cross-section and that has the single uniform phase.

The X-ray waveguide according to the embodiment advantageously satisfies the formula (1) in an entire region of the curved portion. When the substances constituting the periodic structure are not changed in the X-ray guiding direction, it can be said as being sufficient that the formula (1) is satisfied in a region where the curvature radius R is minimal.

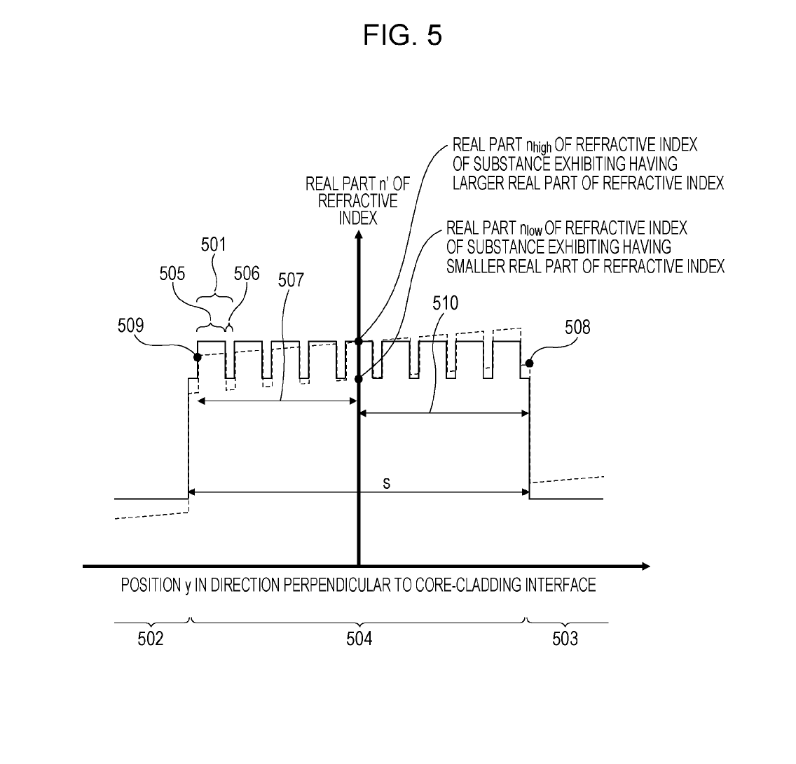

FIG. 5 illustrates one example of a distribution of the refractive-index real part in the direction (y-direction) perpendicular to the interface between the core and the cladding in the X-ray waveguide core according to the embodiment. In FIG. 5, a solid line and a dotted line represent respective distributions of the refractive-index real part when the guiding direction is linear and when the guiding direction is curved. In the y-direction, numerals 502 and 503 denote cladding regions, and 504 denotes a core region. Numeral 501 denotes a region of a unit structure. The unit structure is constituted by a region 505 made of a substance having a larger real part of refractive index, and a region 506 made of a substance having a smaller real part of refractive index. By arraying the unit structures in plural, the refractive-index real part is periodically distributed in the y-direction inside the core, as illustrated in FIG. 5. A linear line (which can also be called a locus) interconnecting individual centers of the core and representing the guiding direction is positioned at y=0. It is known that, in a portion where the guiding direction is curved, an entire distribution of the refractive index is inclined relative to that in the case where the guiding direction of the X-ray waveguide is linear, as illustrated in FIG. 5, when the curved waveguide is approximated as a linear waveguide. Given that n₀(y) represents the distribution of the refractive index denoted by the solid line in FIG. 5, i.e., given that n₀′(y) represents the distribution of the refractive-index real part expressed by the formula (2), a distribution of the refractive index in the curved portion where the guiding direction is curved at the curvature radius R in the plane parallel to the guiding direction and perpendicular to the interface between the core and the cladding can be approximately expressed by:

$${n}_{0} ( y ) {e}^{\frac{y}{R}}$$

A distribution of the refractive-index real part denoted by the dotted line in FIG. 5 can be expressed by:

$${n}_{0}^{′} ( y ) {e}^{\frac{y}{R}}$$

In order that the periodic resonant waveguide mode can be formed even when the distribution of the refractive index is inclined, the refractive-index real part of the substance having a larger real part of refractive index near one end of the core has to be larger than the refractive-index real part of the substance having a smaller real part of refractive index near an opposite end of the core. Thus, the refractive-index real part denoted by 509 has to be larger than that denoted by 508. Given that y_{high} is a distance 507 from the center of the core to a position corresponding to the refractive-index real part, denoted by 509, near the one end of the core, y_{low} is a distance 510 from the center of the core to a position corresponding to the refractive-index real part, denoted by 508, near the opposite end of the core, n_{high} is the refractive-index real part of the substance having a larger real part of refractive index among the substances constituting the periodic structure, n_{low} is the refractive-index real part of the substance having a smaller real part of refractive index among them, and s is the width of the core, the following formula (9) has to be satisfied in the portion where the guiding direction is the curved.

$${n}_{high} exp ( - \frac{{y}_{high}}{R} ) > {n}_{low} exp ( \frac{{y}_{low}}{R} ) \qquad ( 9 )$$

Thus, the formula (1) is obtained on the basis of approximation of:

y_{low}≈y_{high}≈s/2

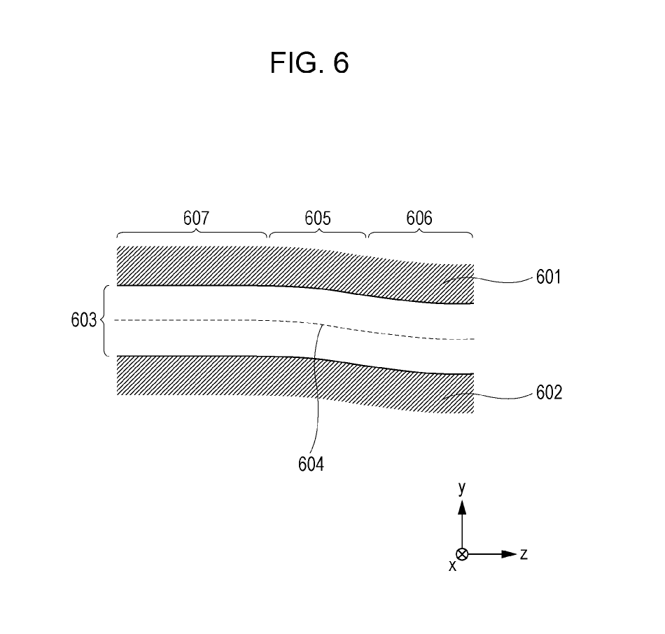

FIG. 6 illustrates a simple example of the X-ray waveguide according to the embodiment of the present invention, which includes the curved portion where the shape of the X-ray waveguide is curved. The X-ray waveguide illustrated in FIG. 6 includes a portion 607 in which the guiding direction is linear, and portions 605 and 606 in which the guiding direction is curved. A core 603 is sandwiched between claddings 601 and 602. While the core has a periodic distribution of the refractive index in the direction perpendicular to the interface between the core and the cladding in FIG. 6, a periodic structure is not illustrated for the sake of simplification. A dotted line 604 denotes the guiding direction. The curved portion 605 has a curvature radius R₁, and the curved portion 606 has a curvature radius R₂. When physical properties and structural parameters of the X-ray waveguide are set to satisfy the formulae (1), (5) and (6) in both the curved portions 605 and 606, the guiding direction for the X-ray in the single periodic resonant waveguide mode, which is formed inside the waveguide and which has a uniform phase, can be changed as denoted by the dotted line 604 in FIG. 6.

Moreover, the X-ray waveguide according to the embodiment is advantageously constructed such that, when the Bragg angle is denoted by θ_{B}(rad), a length of the waveguide in the curved portion is 2Rθ_{B}.

As described above with reference to FIG. 8, the X-ray emerging from the end surface of the waveguide in the periodic resonant waveguide mode is diffracted at a diffraction angle, which is substantially equal to the Bragg angle, in two oppositely equivalent directions in the far-field region with respect to the guiding direction at the emergent end surface of the waveguide. Conversely, when the X-ray is coupled to the periodic resonant waveguide mode through the end surface of the waveguide, higher coupling efficiency to the periodic resonant waveguide mode can be obtained by causing the X-ray to enter an incident end of the waveguide at the Bragg angle with respect to the guiding direction in a plane that is perpendicular to the interface between the core and the cladding and that is parallel to the guiding direction. FIG. 7 illustrates a process in which the X-ray enters one end surface of the X-ray waveguide according to the embodiment to be coupled to the periodic resonant waveguide mode, and in which the X-ray guided in the periodic resonant waveguide mode emerges from the other end surface of the waveguide. As in FIG. 6, a periodic structure of the core 703 is omitted for the sake of simplification. Numeral 705 denotes an incident X-ray, and 706 and 707 denote diffracted X-rays diffracted in two directions, i.e., propagating X-rays in the far-field region, which are generated upon the X-ray in the periodic resonant waveguide mode emerging from the other end surface of the waveguide. In the X-ray waveguide, the claddings 701 and 702 sandwich the core 703 having the periodic structure therebetween, and the guiding direction is denoted by a dotted line 704. By causing the incident X-ray 705 to enter the incident end surface of the waveguide at the Bragg angle with respect to a linear line 708 that represents the guiding direction at the incident end surface, the incident X-ray 705 is coupled to the periodic resonant waveguide mode inside the waveguide at high efficiency. The guiding direction in the waveguide, denoted by the dotted line 704, is curved at a curvature radius R, and the X-ray in the periodic resonant waveguide mode is curved along the guiding direction. The X-ray guided in the periodic resonant waveguide mode and emerging from the other end of the waveguide, i.e., from an emergent end surface thereof, is diffracted in two directions at the Bragg angle with respect to a linear line 709 that represents the X-ray guiding direction at the emergent end surface. Given that the Bragg angle attributable to the periodic structure of the core is θ_{B}(rad) and the length of the waveguide, i.e., the length of the dotted line 704, is L, the incident X-ray 705 and the emergent X-ray 706 propagate on the same axis in a plane parallel to the surface of the drawing sheet on condition that the X-ray waveguide satisfies the following formula (10):

L=2Rθ_{B} (10)

Thus, by constructing the X-ray waveguide according to the embodiment with satisfaction of the formula (10), it is possible to form the X-ray in the periodic resonant waveguide mode and to obtain the X-ray having a very small divergence angle and a spatially uniform phase without changing an optical axis of an X-ray optical system. As a matter of course, the formula (10) is not necessarily required to be held in terms of strict meaning, and an error depending on a demanded system is allowed. Thus, in this specification, the case where an error is within an allowable error range is also construed as satisfying the formula (10).

In the drawings attached to the present disclosure, the X-ray is denoted by an arrow. It is to be noted that the arrow depicts a typical part of X-rays having a width in the direction perpendicular to the propagating direction for convenience of explanation, and it does not depict all of the propagating X-rays. The arrow depicting the X-ray is intended to specifically indicate, e.g., the propagating direction of the X-ray in the drawings, which are referred to in the description. In particular, the incident X-ray is applied to at least the entire cross-section of the core at the incident end of the waveguide, and the emergent X-ray emerges from the entire cross-section of the core at the emergent end of the waveguide.

The periodic structure constituting the core of the X-ray waveguide according to the embodiment has, in a plane perpendicular to the guiding direction and to the interface between the core and the cladding, a periodic distribution of the refractive-index real part in the direction perpendicular to the interface between the core and the cladding. The simplest material providing such a periodic structure is a multilayer film. The multilayer film is constituted by periodically laminating a plurality of substance layers each having a different real part of refractive index. A particularly advantageous example of the periodic structure is obtained by alternately laminating a substance having a higher electron density (i.e., a smaller value of the refractive-index real part) and a substance having a lower electron density (i.e., a larger value of the refractive-index real part).

A method of laminating the layers can be performed by, e.g., sputtering that is used in a semiconductor process. Examples of the substance, which has a higher electron density with a comparatively small absorption loss of the X-ray and which can be laminated when the sputtering is used, include aluminum oxide (Al₂O₃), silicone carbide (SiC), silicon nitride (Si₃N₄), magnesium oxide (MgO), and titanium oxide (TiO₂). Examples of the substance, which has a lower electron density with a comparatively small absorption loss of the X-ray and which can be laminated when the sputtering is used, include beryllium (Be), boron (B), boron carbide (B₄C), boron nitride (BN), and carbon (C). It is to be noted that the substances usable here are not limited to the above-mentioned examples.

The multilayer film may be provided as a mesostructured material having a lamellar structure, which is a one-dimensional periodic structure formed by self-assembly of amphipathic molecules. Such a mesostructured material has the form in which an oxide, e.g., silica, tin oxide, or titanium oxide, and an organic substance are alternately positioned one above the other, and it can be fabricated by, e.g., the sol-gel method.

When the periodic structure is constituted as the mesostructured material, the periodic structure is not limited to the mesostructured material having the lamellar structure, and a mesostructured material in which pores or voids filled with organic substance are periodically arrayed inside an oxide material in the plane perpendicular to the guiding direction. While the latter mesostructured material has a two-dimensional structure in the plane perpendicular to the guiding direction, it can be regarded as having one-dimensional periodic structure in which an average refractive index is periodically changed in the direction perpendicular to the interface between the core and the cladding. Therefore, the latter mesostructured material can be advantageously used as the periodic structure constituting the core of the X-ray waveguide according to the embodiment.

Furthermore, the periodic structure can be made of a mesoporous material that is obtained by removing the organic substance filling the pores or the voids in the mesostructured material. Using the mesoporous material can reduce the absorption loss of the X-ray because the mesoporous material includes vacant portions. Orientations of the pores may be controlled to reduce attenuation of the X-ray. In this specification, as described above, air and vacuum are also involved in the concept of the “substance”. Accordingly, even when the pores in the mesoporous material are occupied by air or vacuum, the mesoporous material can be regarded as forming the mesostructured material made of plural substances because of including portions having different refractive indices.

When the X-ray waveguide according to the embodiment is constructed with satisfaction of the formula (6), a substance forming the cladding is advantageously selected from substances having higher electron densities, such as Au, W, Ta, Pt, Ir and Os, in order to strongly cause the total reflection for confining the X-ray inside the core.

An X-ray waveguide system according to an embodiment of the present invention will be described below. The X-ray waveguide system according to the embodiment includes at least an X-ray source and an X-ray waveguide. The X-ray source emits, as an X-ray, an electromagnetic wave in a general X-ray band with wavelength of 1 pm or longer to 100 nm or shorter. The X-ray emitted from the X-ray source may be an X-ray having a single wavelength or a certain width of wavelength. The X-ray emitted from the X-ray source enters an X-ray waveguide. The X-ray waveguide in the X-ray waveguide system according to the embodiment can be provided as the above-described X-ray waveguide.

### EXAMPLE 1

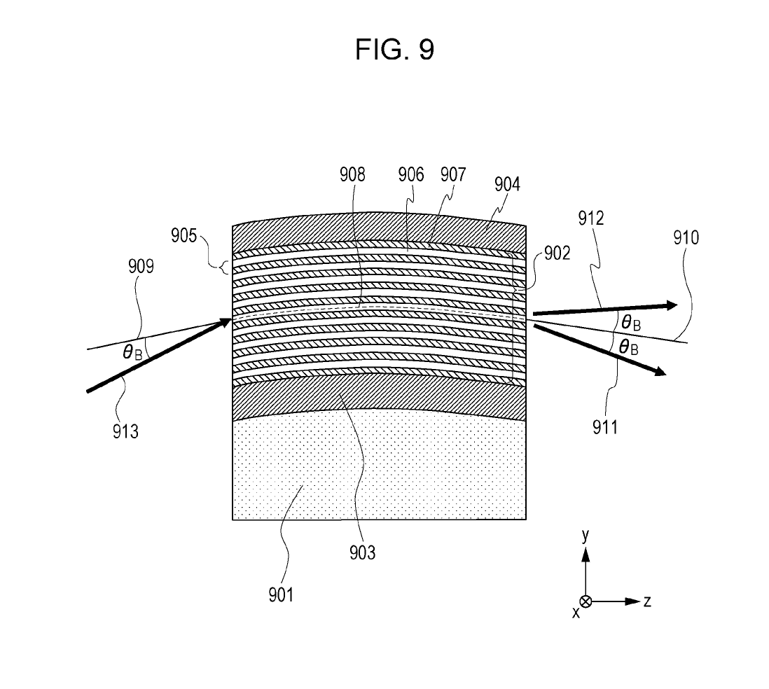

FIG. 9 illustrates a section of an X-ray waveguide according to EXAMPLE 1 of the present invention, the section being perpendicular to a substrate surface and including a guiding direction. In the structure of the X-ray waveguide of EXAMPLE 1, an up-and-down direction is defined such that a substrate portion is disposed at a lowermost position. The X-ray guiding direction is denoted by a dotted line 908 in FIG. 9. The length of the waveguide, which corresponds to the length of the dotted line 908, is about 3 mm. Numeral 901 denotes a substrate made of quartz. The surface of the quartz substrate 901 is formed by polishing into a curved surface that has a cylindrical shape with a curvature radius of 2 m in the yz-plane in FIG. 9. A lower cladding 903 made of W and having a thickness of 20 nm, a multilayer film 902 that is a periodic structure constituting a core, and an upper cladding 904 made of W and having a thickness of 20 nm are successively formed on the quartz substrate 901 by sputtering. The multilayer film 902 constitutes the periodic structure in which a carbon (C) layer 906 having a thickness of 12 nm and an aluminum-oxide (Al₂O₃) layer 907 having a thickness of 4 nm are alternately laminated. The periodic structure has a periodic number of 50 and a period of 16 nm in the direction perpendicular to the interface between the core and the cladding. Additionally, uppermost and lowermost portions of the core are each formed of a film of Al₂O₃ having a smaller real part of refractive index. For an X-ray having photon energy of 8 keV, a critical angle for the total reflection at the interface between the core and the cladding is about 0.51°, a critical angle for the total reflection at an interface between the aluminum oxide and the carbon, which constitute a unit structure in the multilayer film, is about 0.19°, and a Bragg angle attributable to periodicity of the multilayer film is about 0.35°. Accordingly, the formulae (5) and (6) are satisfied, and the periodic resonant waveguide mode becomes a dominant waveguide mode in the X-ray waveguide of EXAMPLE 1. Since the X-ray waveguide of EXAMPLE 1 is curved in the yz-plane at the curvature radius of 2 m, the X-ray of the periodic resonant waveguide mode in the waveguide is guided through the waveguide while being curved along the guiding direction denoted by the dotted line 908. Here, the core has a width of about 804 nm in the direction perpendicular to the core and the cladding. For the X-ray having photon energy of 8 keV, the refractive-index real part of the cladding has a value of about 0.999952992, and the refractive-index real part of the aluminum oxide, which has a smaller real part of refractive index among the substances of the multilayer film, has a value of about 0.9999872224544. Accordingly, the formula (1) is satisfied, and the X-ray can be guided in the periodic resonant waveguide mode while it is confined inside the core. When the guiding direction at an X-ray incident end surface of the waveguide is denoted by a linear line 909 and the guiding direction at an X-ray emergent end surface of the waveguide is denoted by a linear line 910, an angle formed between the linear lines 909 and 910 is 0.08°. Thus, the guiding direction of the periodic resonant waveguide mode is changed 0.08° by the X-ray waveguide of EXAMPLE 1. For example, when an X-ray 913 enters at the Bragg angle of about 0.35° with respect to the guiding direction at the X-ray incident end surface, an X-ray emerging from the emergent end surface forms emergent X-rays 911 and 912 in the far-field region, which are each diffracted at about 0.35° with respect to the guiding direction at the emergent end surface. By selecting one 911 of the emergent X-rays, the direction of the incident X-ray can be changed about 0.78°. Moreover, since the periodic resonant waveguide mode formed in the X-ray waveguide of EXAMPLE 1 is employed, the emergent X-ray is provided as a propagating X-ray having a very small divergence angle and a spatially uniform phase.

### EXAMPLE 2

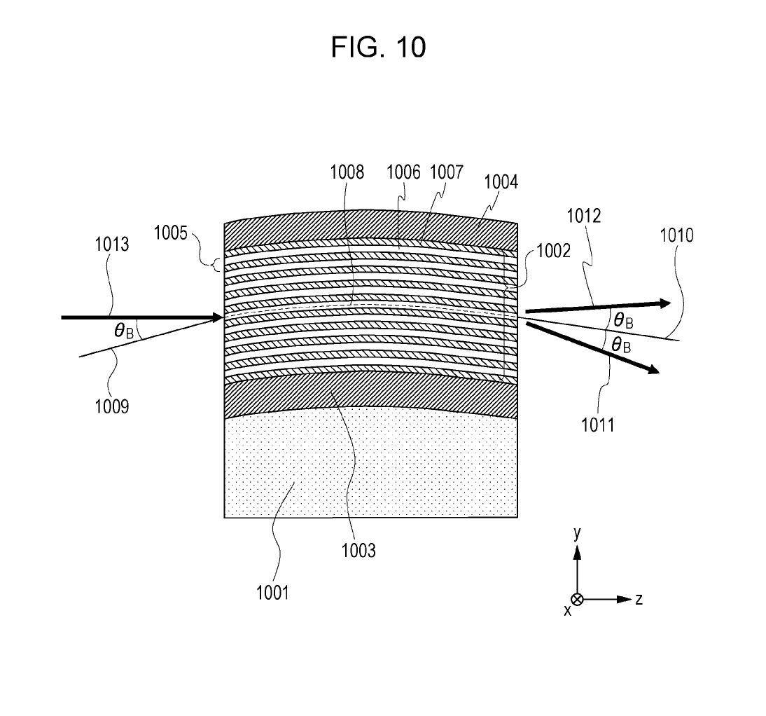

FIG. 10 illustrates a section of an X-ray waveguide according to EXAMPLE 2 of the present invention, the section being perpendicular to a substrate surface and including a guiding direction. On a quartz substrate 1001 having a surface formed by polishing into a cylindrical surface that is curved at a curvature radius of about 1 m, a lower cladding 1003 made of tungsten (W) and having a thickness of about 20 nm, a multilayer film 1002 constituting a core, and an upper cladding 1004 made of tungsten (W) and having a thickness of about 20 nm are successively formed by sputtering. A dotted line 1008 passing a center of the core in the above-mentioned section denotes the X-ray guiding direction, and the length of the dotted line 1008 is defined as the length of the waveguide. In EXAMPLE 2, the length of the waveguide is about 10.5 mm. The multilayer film 1002 is a periodic structure constituting the core, which is formed by laminating 100 layers of unit structures 1005 each including an aluminum-oxide (Al₂O₃) layer 1007 having a thickness of about 3 nm and a boron-carbide (B₄C) layer 1006 having a thickness of about 12 nm. The periodic structure has a period of about 15 nm and a periodic number of 100. Additionally, uppermost and lowermost layers of the multilayer film are each formed of a layer of aluminum oxide. For an X-ray having photon energy of 10 keV, a critical angle for the total reflection at the interface between the core and the cladding is about 0.43°, a critical angle for the total reflection at an interface between the aluminum oxide and the carbon, which constitute the unit structure in the multilayer film, is about 0.18°, and a Bragg angle θ_{B}(°) attributable to the multilayer film is about 0.3°. Accordingly, the X-ray waveguide of EXAMPLE 2 satisfies the formulae (5) and (6), and it can form the periodic resonant waveguide mode to guide the X-ray in that mode. Furthermore, the length of the X-ray waveguide of EXAMPLE 2 is about 10.5 mm and satisfies the formula (10). By causing the X-ray to enter the waveguide at the Bragg angle with respect to a linear line 1009 that denotes the guiding direction near an incident end of the waveguide as illustrated in FIG. 10, an incident X-ray 1013 is coupled to the periodic resonant waveguide mode with high efficiency, whereby the X-ray in the periodic resonant waveguide mode emerges from an emergent end of the waveguide after being guided therethrough. The X-ray emerging from the emergent end surface forms emergent X-rays 1011 and 1012 diffracted in two directions each forming the Bragg angle with respect to a linear line 1010, which represents the guiding direction near the emergent end of the waveguide. Because the X-ray waveguide of EXAMPLE 2 is constructed with satisfaction of the formula (10), the incident X-ray 1013 and the emergent X-ray 1012 propagate on the same axis. This is advantageous in that an optical axis is not changed in an X-ray optical system.

### EXAMPLE 3

In an X-ray waveguide according to EXAMPLE 3 of the present invention, the core of the X-ray waveguide described in EXAMPLE 1 is replaced with a mesostructured material having a lamellar structure. The mesostructured material having the lamellar structure, which constitutes the core of the X-ray waveguide of EXAMPLE 3, is formed on a cladding made of tungsten and formed on a quartz substrate. In the mesostructured material, a layer of an organic substance, i.e., a substance having a larger real part of refractive index, with a thickness of about 7.7 nm and a layer of silica, i.e., a substance having a smaller real part of refractive index, with a thickness of about 3.3 nm are alternately laminated such that a one-dimensional periodic distribution of the refractive index is provided in the direction perpendicular to the interface between the core and the cladding. The mesostructured material having the lamellar structure has a period of about 11 nm and a periodic number of 48. The length of the waveguide is about 4 mm. The mesostructured material having the lamellar structure, according to EXAMPLE 3, is formed by dip-coating using a precursor solution, which is prepared by adding a precursor of an inorganic oxide into a solution of a surfactant that functions as a mold in an aggregated form. Here, the precursor solution is prepared by employing a block polymer as the surfactant, tetraethoxysilane as the precursor of the inorganic oxide, and ethanol as a solvent, by adding water and hydrochloric acid for hydrolysis of the precursor of the inorganic oxide, and by stirring the mixture. A mixing ratio (molar ratio) is set to tetraethoxysilane: 1, block polymer: 0.0264, water: 8, hydrochloric acid: 0.01, and ethanol: 40. A tri-block copolymer of polyethylene glycol (20)—polypropylene glycol (70)—polyethylene glycol (20) is used as the block polymer (numeral in the parenthesis denotes the repetition number of each block). The mesostructured material having the lamellar structure is formed through a self-organization process that occurs during evaporation of the solvent of the introduced solution. For an X-ray having photon energy of 8 keV, a critical angle for the total reflection at an interface between the organic substance and the silica, which constitute a unit structure in the mesostructured material having the lamellar structure, is about 0.13°, a critical angle for the total reflection at the interface between the core and the cladding is about 0.53°, and a Bragg angle attributable to the mesostructured material having the lamellar structure is about 0.44°. Accordingly, the structure of the X-ray waveguide of EXAMPLE 3 satisfies the formulae (5) and (6). Thus, the periodic resonant waveguide mode can be formed, and the X-ray in the periodic resonant waveguide mode can be guided and curved by the X-ray waveguide of EXAMPLE 3. The guiding direction is changed about 0.115° between an X-ray incident end and an X-ray emergent end of the waveguide.

### EXAMPLE 4

In an X-ray waveguide according to EXAMPLE 4 of the present invention, the mesostructured material having the lamellar structure, which constitutes the core of the X-ray waveguide described in EXAMPLE 3, is replaced with a mesoporous material. The length of the waveguide is about 3 mm. The mesoporous material constituting the core of the X-ray waveguide of EXAMPLE 4 is a mesoporous silica material in which a large number of pores having a uniform diameter are present in silica. The mesoporous silica material has a two-dimensional structure in a section perpendicular to the guiding direction. However, a layer containing air portions in a larger amount and a layer containing silica portions in a larger amount are alternately laminated in the direction perpendicular to the interface between the core and the cladding, and the mesoporous material has such a distribution of the refractive index that an average refractive index is periodically changed in the direction perpendicular to the interface between the core and the cladding. Thus, the mesoporous material provides a one-dimensional periodic structure in the direction perpendicular to the interface between the core and the cladding. The one-dimensional periodic structure has a period of about 10 nm and a periodic number of 50. In particular, the mesoporous material in which pores in the mesoporous silica are made vacant through a mold removing process after forming a mesoporous film can reduce a propagation loss of the X-ray. A precursor solution for the mesoporous silica is obtained by setting a mixing ratio (molar ratio) to tetraethoxysilane: 1, block polymer: 0.0096, water: 8, hydrochloric acid: 0.01, and ethanol: 40 in the method for preparing the precursor solution, which has been described in EXAMPLE 3. The mesoporous film is prepared through the steps of applying the precursor solution over a lower cladding made of tungsten, drying and aging the applied precursor solution, dipping it into a solvent, and extractively removing the block polymer that has served as the mold. Thus, the core of the X-ray waveguide of EXAMPLE 4 is made of the mesoporous silica that is obtained after removing organic substances in the pores at the same time as the mold removing step. Because the periodic structure is not a film laminated structure unlike the mesostructured material having the lamellar structure, a critical angle for the total reflection is not definitely defined in a unit structure of the mesoporous silica in the direction perpendicular to the interface between the core and the cladding. Such a case also satisfies the formula (5). For an X-ray having photon energy of 10 keV, a critical angle for the total reflection at the interface between the core and the cladding is about 0.43°, and a Bragg angle attributable to the mesostructured material made of the mesoporous silica, i.e., corresponding to periodicity of an average value of the refractive-index real part in the direction perpendicular to the interface between the core and the cladding, is about 0.36°. Accordingly, the formula (6) is further satisfied. As a result, the X-ray in the periodic resonant waveguide mode can be guided and curved by the X-ray waveguide of EXAMPLE 4. The guiding direction is changed about 0.09° between an X-ray incident end and an X-ray emergent end of the waveguide.

### EXAMPLE 5

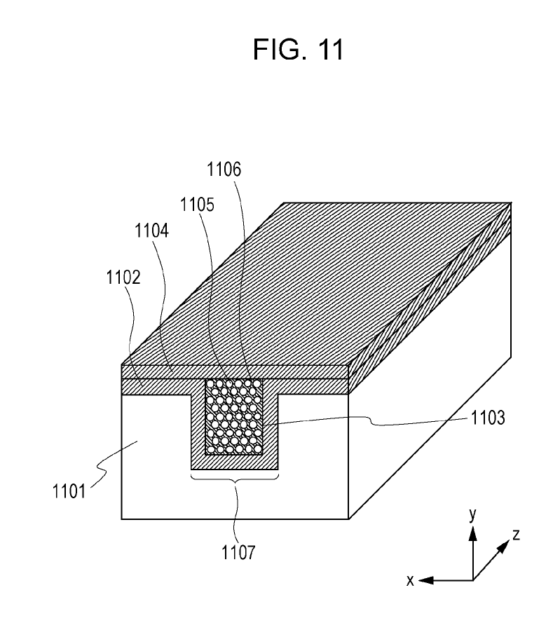

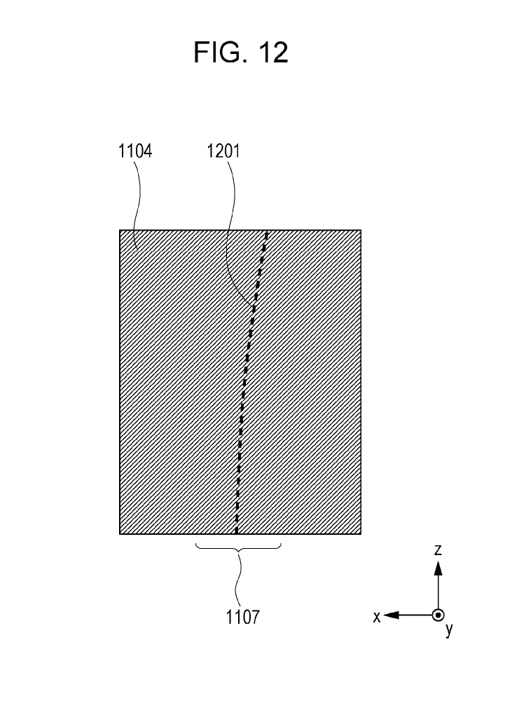

FIG. 11 illustrates an X-ray waveguide of EXAMPLE 5. The X-ray waveguide of EXAMPLE 5 is featured in that the guiding direction is curved in a flat substrate surface. A core of the X-ray waveguide is made of the mesoporous silica material described in EXAMPLE 4. In the structure of the X-ray waveguide of EXAMPLE 5, an up-and-down direction is defined such that a substrate portion is disposed at a lowermost position. A groove 1107 having a width of about 1 μm and a depth of about 1 μm and being curved at a curvature radius of 2 m in a zx-plane in FIG. 11 is formed in a flat silicon (Si) substrate 1101 by electron beam lithography and dry etching. Thereafter, a first cladding 1102 made of tungsten and having a thickness of about 20 nm is formed in the groove 1107 by sputtering. The precursor solution of the mesoporous silica material is then coated over the first cladding 1102 by dip-coating. As a result, a mesostructured material is formed on the first cladding 1102 by self-organization during evaporation of a solvent. After removing the mesoporous material formed in a region other than the groove 1107 by polishing, a second cladding 1104 made of tungsten and having a thickness of 20 nm is further formed on a surface of the mesostructured material by sputtering. Thus, the X-ray waveguide including a core 1103 surrounded by the claddings in an xy-plane in FIG. 11 is formed. The guiding direction is curved at the curvature radius of 2 m in a direction parallel to the substrate surface, i.e., in the zx-plane, as denoted by a dotted line 1201 in FIG. 12. Accordingly, the formula (1) is satisfied. The above-mentioned result is based on the fact that the groove 1107 formed in the substrate 1101 has a curved shape. The mesoporous material has such a periodic structure that voids 1105 extending in the guiding direction are periodically arrayed in silica 1106, and that an average refractive-index real part has a periodic distribution in the x-direction in FIG. 11. The periodic structure has a period of about 12 nm and a periodic number of 80 in the x-direction. Because, as in EXAMPLE 4, the periodic structure is not a film laminated structure unlike the mesostructured material having the lamellar structure, a critical angle for the total reflection is not definitely defined in a unit structure of the mesoporous silica in the direction perpendicular to the interface between the core and the cladding. Such a case also satisfies the formula (5). For an X-ray having photon energy of 8 keV, a critical angle for the total reflection in the zx-plane at an interface between the first cladding 1102 and the core 1103, the interface being parallel to a yz-plane, is about 0.53°, and a Bragg angle attributable to periodicity of the periodic structure in the x-direction is about 0.38°. Accordingly, the X-ray waveguide of EXAMPLE 5 enables the X-ray in the periodic resonant waveguide mode to be curved in a plane parallel to the substrate. Since the mesoporous silica material in EXAMPLE 5 has two-dimensional periodicity in a plane perpendicular to the guiding direction, the periodic resonant waveguide mode is formed as a waveguide mode that resonates with the two-dimensional periodicity, and that has a uniform phase in the plane perpendicular to the guiding direction. The length of the waveguide is about 4 mm, and the guiding direction near an X-ray emergent end of the waveguide is eventually changed about 0.12° from that near an X-ray incident end of the waveguide.

According to the above-described embodiments of the present invention, the X-ray waveguides each having the single waveguide mode in a uniform phase over a wide cross-section of the core and including the curved portion can be obtained. Furthermore, the X-ray waveguides according to the embodiments of the present invention can be each employed in X-ray optical technique fields as a component that is used, for example, in an X-ray optical system for handling an X-ray output from a synchrotron, and in X-ray optical systems for, e.g., X-ray imaging technology and X-ray exposure technology.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-265069 filed Dec. 2, 2011, which is hereby incorporated by reference herein in its entirety.

What is claimed is:

1. An X-ray waveguide including a core configured to guide an X-ray therethrough and a cladding configured to confine the X-ray inside the core,
wherein the core has a periodic structure in which plural substances each having a different real part of refractive index are periodically arrayed in a direction perpendicular to an interface between the core and the cladding,
a critical angle for the total reflection of the X-ray at the interface between the core and the cladding is larger than a Bragg angle attributable to the periodic structure of the core for the X-ray,
a critical angle for the total reflection at an interface between the plural substances constituting the periodic structure of the core is smaller than the Bragg angle,
the core includes a curved portion, and
a following formula is satisfied:
$$\frac{s}{ln ( \frac{{n}_{high}}{{n}_{low}} )} < R$$
where s is a width of the core in a direction perpendicular to an X-ray guiding direction and parallel to a direction in which a curvature radius is defined of the curved portion, n_{low} is a refractive-index real part of the substance having a minimum real part of refractive index real part among the substances of the core, n_{high} is a refractive-index real part of the substance having a maximum real part of refractive index among the substances of the core, and R is the curvature radius of the curved portion.

2. The X-ray waveguide according to claim 1, wherein, given that the Bragg angle is θ_{B}(rad), a length of the waveguide at a center thereof in the curved portion is 2Rθ_{B}.

3. The X-ray waveguide according to claim 1, wherein the core is a multilayer film in which the substances each having a different real part of refractive index are periodically laminated.

4. The X-ray waveguide according to claim 1, wherein the core is a mesostructured material.

5. The X-ray waveguide according to claim 1, wherein the core is made of a mesoporous material.

6. An X-ray waveguide system including an X-ray source and an X-ray waveguide,
the X-ray source emitting an X-ray to the X-ray waveguide,
the X-ray waveguide including a core configured to guide an X-ray therethrough and a cladding configured to confine the X-ray inside the core,
wherein the core has a periodic structure in which plural substances each having a different real part of refractive index are periodically arrayed in a direction perpendicular to an interface between the core and the cladding,
a critical angle for the total reflection of the X-ray at the interface between the core and the cladding is larger than a Bragg angle attributable to the periodic structure of the core for the X-ray,
a critical angle for the total reflection at an interface between the plural substances constituting the periodic structure of the core is smaller than the Bragg angle,
the core includes a curved portion, and
a following formula is satisfied:
$$\frac{s}{ln ( \frac{{n}_{high}}{{n}_{low}} )} < R$$
where s is a width of the core in a direction perpendicular to an X-ray guiding direction and parallel to a direction in which a curvature radius is defined of the curved portion, n_{low} is a refractive-index real part of the substance having a minimum real part of refractive index part among the substances of the core, n_{high} is a refractive-index real part of the substance having a maximum real part of refractive index among the substances of the core, and R is the curvature radius of the curved portion.

7. The X-ray waveguide system according to claim 6, wherein, given that the Bragg angle is θ_{B}(rad), a length of the waveguide at a center thereof in the curved portion is 2Rθ_{B}.

8. The X-ray waveguide system according to claim 6, wherein the core is a multilayer film in which the substances each having a different real part of refractive index are periodically laminated.

9. The X-ray waveguide system according to claim 6, wherein the core is a mesostructured material.

10. The X-ray waveguide system according to claim 6, wherein the core is made of a mesoporous material.
